(19) United States
(12) Patent Application Publication
(10) Pub. No.: US 2008/0056265 A1
(43) Pub. Date: Mar. 6, 2008

(54) Method For Differentiating Pseudowire Packets From Multi-Protocol Label Switching Packets

(76) Inventors: Fan-San Choi, Hsinchu (TW); Ting-Chao Hou, Chia-Yi (TW); Woei-Luen Shyu, Chang-Hua (TW)

Correspondence Address: LIN & ASSOCIATES INTELLECTUAL PROPERTY, INC., P.O. BOX 2339, SARATOGA, CA, 95070-0339, US

(21) Appl. No.: 11/616,107

(22) Filed: Dec. 26, 2006

(30) Foreign Application Priority Data
Sep. 1, 2006 (TW) 095132415

(51) Int. Cl. H04L 12/56

(52) U.S. Cl. 370/392

(57) ABSTRACT

Disclosed is a method for differentiating pseudowire (PW) packets from multi-protocol label switching (MPLS) packets. It uses particular time-to-live (TTL) values to differentiate PW packets from MPLS packets, thereby to create additional label spaces and to maximize the total number of PWs and label switching paths that can be simultaneously in use. At an ingress PW device, when an incoming packet is encapsulated into a PW packet, the TTL field of the corresponding PW header is set to one of particular values. At an egress MPLS device, after a packet is received, the value of the TTL field of its MPLS header is compared with these particular values. If the TTL value is equal to one of particular values, this packet is a PW packet and belongs to the PW label space of the particular value.

### FIELD OF THE INVENTION

The present invention generally relates to a method for differentiating pseudowire (PW) packets from multi-protocol label switching (MPLS) packets.

### BACKGROUND OF THE INVENTION

In a packet-switched network, a packet from a source address passes through a plurality of network nodes, such as switches or routers, before reaching its destination address. If a network node knows the destination address, this packet is forwarded to an appropriate next hop. Otherwise, this packet is forwarded to a port different from the port receiving this packet.

The multi-protocol label switching technique labels packets and forwards labeled packets according to their label to the next label switching router (LSR) along established label-switched paths. Once a labeled packet reaches the penultimate LSR, i.e. the second to the last LSR along the established label switch path, the label is no longer required and can be removed.

FIG. 1 shows a schematic view of the operation of a conventional MPLS network. An ingress edge LSR 101 labels a packet 110 by pushing a label 110a so that packet 110 becomes packet 120a. Packet 120a is forwarded to a core LSR 103a. Core LSR 103a swaps label 1 10a of packet 120a with label 110b so packet 120a becomes packet 120b. Packet 120b is forwarded to the next core LSR 103b. When packet 120b reaches LSR 103b, label 110b is no longer required. Therefore, LSR 103b pops label 110b and updates packet 120b into packet 130. Packet 130 is further forwarded to an egress edge LSR 111. Egress LSR 111 updates packet 130 into packet 140 for further processing and forwarding.

U.S. Pat. No. 6,728,220 and U.S. Patent Application Publication 2002/0176371 disclosed a technique to prevent any transmission loop in a label switching domain. The technique logically transforms a ring MPLS network into an arc one so that any packet will not be transmitted twice over the same link in the network.

In the above technique, each LSR has a right-side ring port and a left-side ring port, respectively connected to one neighboring LSR. Each LSR must know the number of LSRs in the network in advance. When a LSR intends to transmit a packet, it sets the time-to-live (TTL) field of the MPLS header of the packet to half of the number of LSRs in the network and transmits the packet to both the right-side LSR and the left-side LSR. Therefore, each LSR must know the number of nodes in the ring MPLS network to prevent any loop transmission.

The MPLS technique minimizes routing look-up time and accelerates packet switching, as well as supports quality of service (QoS). In addition, the MPLS technique supports multi-level header, called label stack.

The format of an MPLS header is shown in FIG. 2, including a 20-bit label field (Label), a 3-bit experimental use field (EXP), a 1-bit bottom of stack field (S), and an 8-bit time-to-live field (TTL). Only the S field of the bottommost level header is set to 1 and the others are set to 0. In addition, because there are 20 bits in the Label field, there will be 2̂20 different labels. Since these labels can be used simultaneously, we say that these labels exist in the same label space.

The Pseudowire (PW) technique can employ the MPLS technique, including the use of the header format shown in FIG. 2, to emulate frame relay, ATM, Ethernet, TDM and SONET/SDH services between two customer edge (CE) devices through packet switched network. FIG. 3 shows a schematic view of the operation of the PW technique.

Virtual private network (VPN) is the technology for using a public network, instead of a dedicated network, as a carrier to connect two or more private networks that need to communicate with each other. FIG. 4 shows a schematic view of the VPN technology, where three private networks communicate with each other via three CE devices, and these CE devices are interconnected via provider edge (PE) routers and provider (P) routers in a public network.

In various VPN technologies, one is based on the PW technique using the MPLS technique, called virtual private LAN services (VPLS), as shown in FIG. 5A, where CE devices are connected to PE routers in an MPLS network, and any pair of connected PE routers establish PWs and label switching paths between them. PWs and label switching paths may visit one or more provider routers in the MPLS network.

When a CE device intends to transmit a packet to another CE device, the PE router transforms the packet into a PW packet, and further transforms the PW packet into an MPLS packet. That is, a VPLS packet has two connected headers, called an external header 510 and an internal header 520, respectively. The external header 510 is used for LSP, and the internal header 520 is used for PW. In addition, because an internal header 520 is the bottommost header of the MPLS label stack, the S field is set to 1. The S field of an external header 510 is set to 0.

FIG. 5B shows a schematic view of a method for differentiating pseudowire packets from MPLS packets. When an egress MPLS device receives an MPLS packet, the topmost header of the packet is read. Then the S field of the header is checked to determine whether its value is 1 or not. If its value is not 1, the next header is read and the checking step is repeated. If its value is 1, the next step is to check whether the value of the label field of the header is a PW label. If so, the packet is forwarded to a PW process. Otherwise, the packet is forwarded to an MPLS process.

In the above method, internal headers and external headers share the same label space so the maximum number of PWs and label-switched paths that can co-exist is 2̂20. When the number of VPNs increases or when the number of connected PE routers increases, the number of PWs and label-switched paths also increases, which may lead to the exhaustion of labels and service failure.

It is therefore imperative to provide a method for differentiating PW packets from MPLS packets to expand the maximum of the total number of PWs and label-switched paths that can co-exist.

### SUMMARY OF THE INVENTION

Examples of the present invention may provide a method for differentiating PW packets from MPLS packets so that the label field of internal headers and the label field of external headers belong to separated and independent label spaces. Furthermore, the label field of internal headers can belong to a plurality of independent label spaces so that the maximum of the total number of coexistent PWs and label-switched paths is expanded.

In the present invention, after an ingress PW device receives a packet, it packs the received packet with a PW header and sets the TTL field of the PW header to a special value. After an egress MPLS device receives a packet, it checks whether the TTL field of the header of the packet contains a special value. If so, the packet is a PW packet and belongs to the label space of the special value.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic view of the operation of a conventional MPLS network.

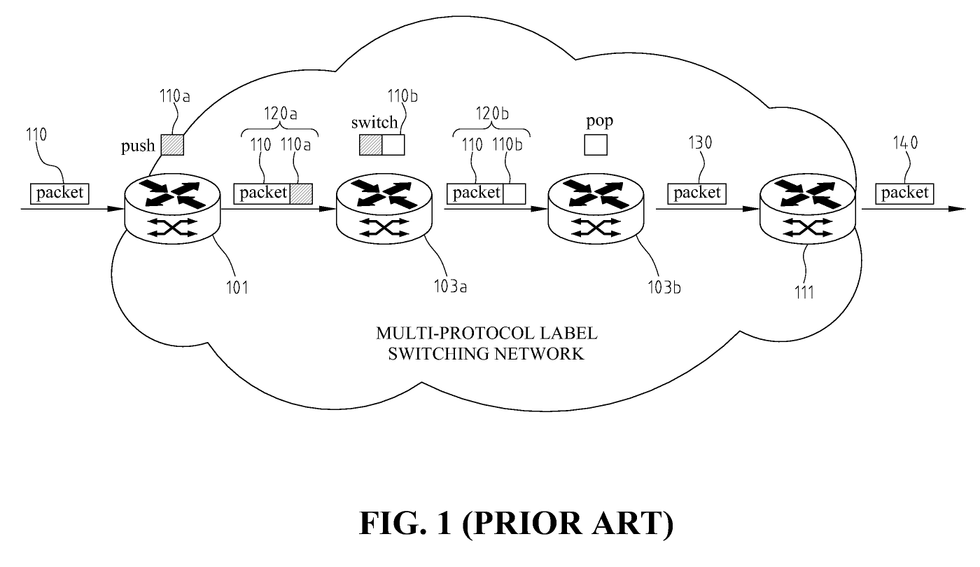

FIG. 2 shows a schematic view of the header format of MPLS packets.

FIG. 3 shows a schematic view of the operation of the PW technique.

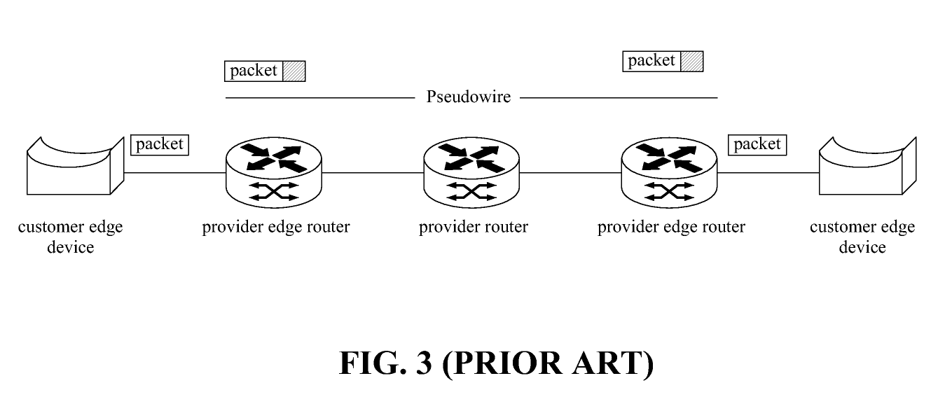

FIG. 4 shows a schematic view of the operation of a conventional VPN network.

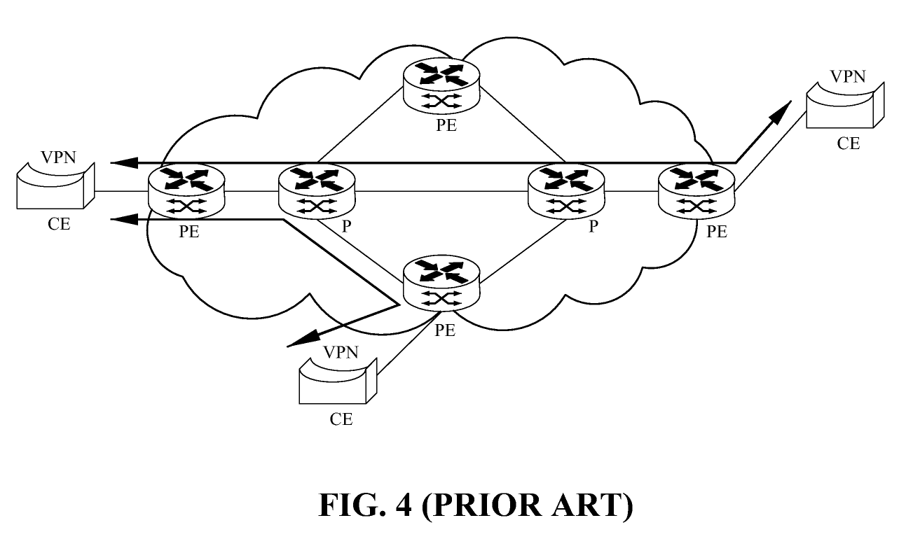

FIG. 5A shows a schematic view of the operation of the VPLS technique.

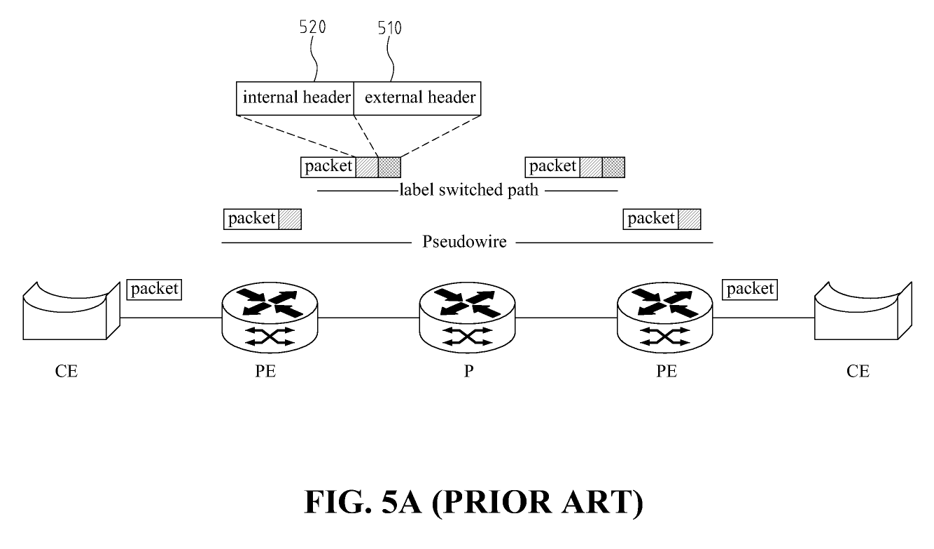

FIG. 5B shows a schematic view of a conventional method for differentiating PW packets from MPLS packets.

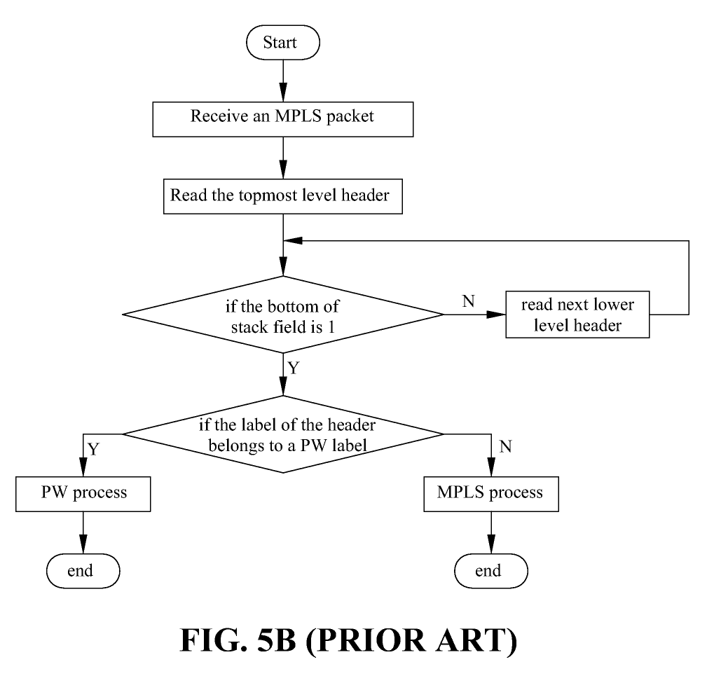

FIG. 6A shows a schematic view of the method for differentiating PW packets from MPLS packets according to the present invention.

FIG. 6B shows the detailed operation of an egress MPLS device of FIG. 6A after a packet is received.

FIG. 7 shows a schematic view of the differentiation of PW packets belonging to different label spaces.

### DETAILED DESCRIPTION OF THE PREFERRED EMBODIMENTS

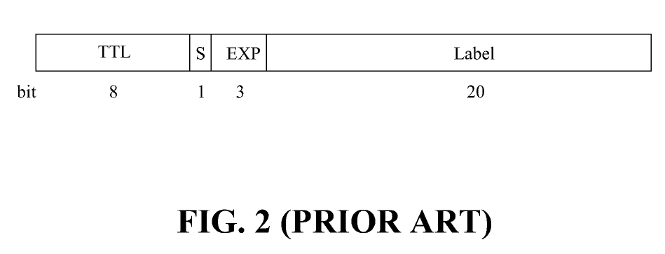

As aforementioned, the PW technique can utilize the MPLS technology, including the header format of MPLS packets shown in FIG. 2. According to Internet RFC 3985, the TTL field of the PW header is application specific. According to Internet RFC 3032, when an MPLS packet passes an MPLS device, the 8-bit TTL field is checked and subtracted by 1. If the TTL field contains 0, the packet is no longer forwarded.

In other words, an application will set the TTL field, in general, to a positive number between 1 and 255, instead of 0. Therefore, the TTL field of MPLS packets received by an egress MPLS device must be greater than or equal to 1. Besides, the value in the TTL field must be less than or equal to 254, instead of equal to 255.

Therefore, the present invention uses the special values, namely, 0 and 255, to increase the number of label spaces of PW. In other words, the same value of the label field of an internal header can belong to multiple independent label spaces, and the value of the label field of an internal header and the value of the label field of an external header can belong to independent label spaces. That is, the labels used by PWs and label-switched paths belong to independent label spaces so that the maximum of the total number of coexistent PWs and label-switched paths is expanded.

The following uses an egress MPLS device which reads MPLS headers of incoming packets as an embodiment for explaining how the value of the TTL field is used for differentiating PW packets from MPLS packets.

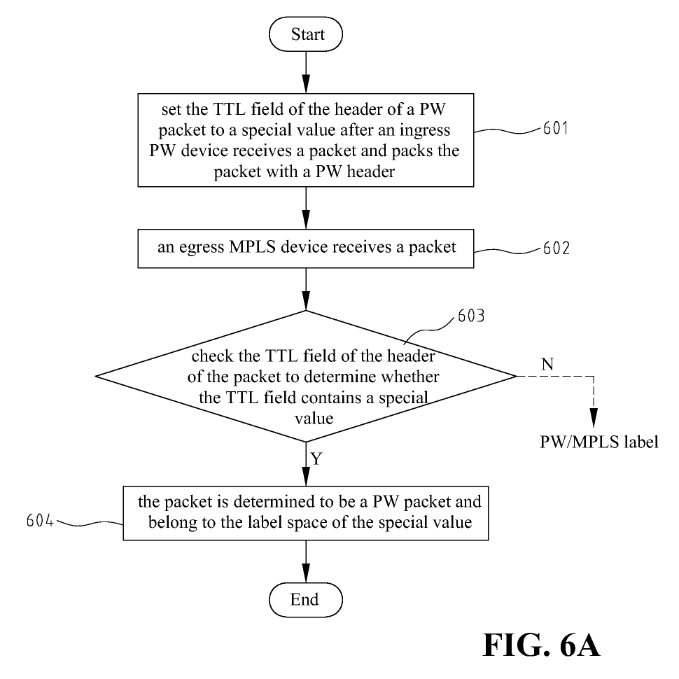

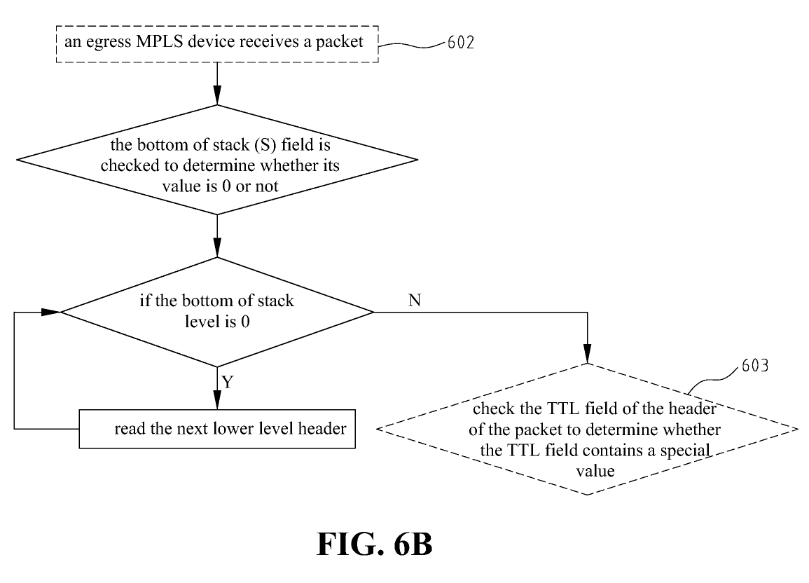

FIG. 6A shows a schematic view of the method for differentiating PW packets from MPLS packets. Step 601 is to set the TTL field of the header of a PW packet to a special value after an ingress PW device receives a packet and packs the packet with a PW header. Step 602 is that an egress MPLS device receives a packet. Step 603 is to check the TTL field of the header of the packet to determine whether the TTL field contains a special value. If so, the packet is determined to be a PW packet and belong to the label space of the special value, as shown in step 604.

If the TTL field of the header does not contain any special value, the value of the label field of the header can be a PW label or an MPLS label.

Between step 602 and step 603, the present invention can further include the following steps, as shown in FIG. 6B. After step 602, the topmost header is read and the bottom of stack (S) field is checked to determine whether it value is 0 or not. If so, the next header is read and its S field is checked, until the S field equals 1. When the S field equals 1, the TTL field of the last-read header is checked to determine whether a special value or not, as shown in step 603.

According to the present invention, the ingress PW device can be an input module of an ingress MPLS device. The PW can be used for VPLS. The special value can be 0, 255, or both at the same time.

When the special value is 0, step 601, 603, and 604 only check for the special value 0. Similarly, when the special value is 255, step 601, 603, and 604 only check for the special value 255.

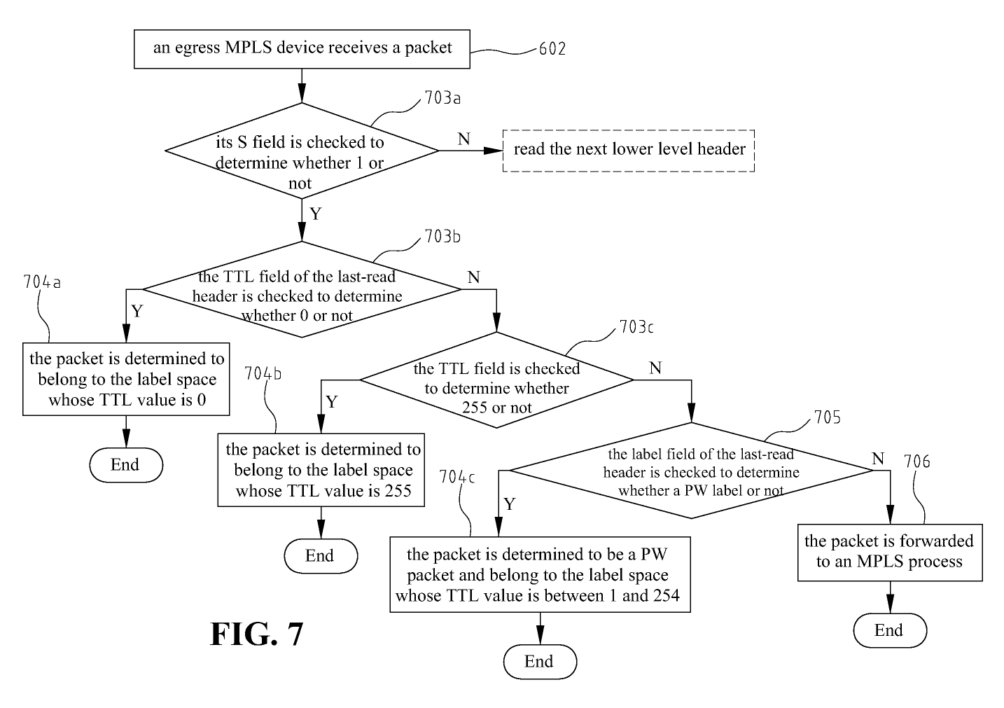

Furthermore, the present invention uses one or more special values of the TTL field to differentiate the PW packets belonging to different label spaces. For example, if both 0 and 255 are used as special values, PW packets can be differentiated into three different label spaces whose values of the TTL fields of the PW headers are 0, 255, and 1-254, respectively. FIG. 7 shows a schematic view of the differentiation of PW packets belonging to different label spaces.

In FIG. 7, after step 602, the topmost header of the packet is read and its S field is checked to determine whether 1 or not, as shown in step 703a. If the value is 0, the next header of the packet is read and its S field is checked, until the value of the S field is 1. When the value of the S field is 1, the TTL field of the last-read header is checked to determine whether 0 or not, as shown in step 703b. If 0, the packet is determined to belong to the label space whose TTL value is 0, as shown in step 704a. If the TTL value is not 0, the TTL field is checked to determine whether 255 or not, as shown in step 703c. If 255, the packet is determined to belong to the label space whose TTL value is 255, as shown in step 704b. If the TTL value is neither 0 nor 255, the label field of the last-read header is checked to determine whether a PW label or not, as shown in step 705. If the label value is a PW label, the packet is determined to be a PW packet and belong to the label space whose TTL value is between 1 and 254, as shown in step 704c. If the label value is not a PW label, the packet is forwarded to an MPLS process, as shown in step 706.

Therefore, PW packets can be differentiated belonging to three different label spaces whose TTL values are 0, 255, and 1-254, respectively.

In summary, the present invention uses one or more special values of the TTL field to differentiate PW packets from MPLS packets. Besides, by using one or more special values, the number of label spaces is increased, and the maximum of the total number of coexistent PWs and label-switched paths is expanded.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for differentiating pseudowire (PW) packets from multi-protocol label switching (MPLS) packets, a header format of each said MPLS packet at least including a label field, a bottom of stack field, and a time-to-live filed, said method comprising the steps of:
setting said time-to-live field of said header format for a PW packet to a special value when packing said packet at an ingress PW device;
receiving said packet at an egress MPLS device;
checking said time-to-live field of said MPLS header of said packet to determine whether the value of said time-to-live field is said special value; and
determining said packet being a PW packet and belonging to a label space of said special value if the value of said time-to-live field is said special value.

2. The method as claimed in claim 1, wherein said ingress PW device is an input module of an ingress MPLS device.

3. The method as claimed in claim 1, wherein said PW is used for a virtual-private-network service.

4. The method as claimed in claim 1, wherein said special value is 0.

5. The method as claimed in claim 1, wherein said special value is 255.

6. The method as claimed in claim 1, wherein said special value includes both 0 and 255.

7. The method as claimed in claim 1, wherein said label field of said packet header is either a PW label or an MPLS label if the value of said time-to-live field of said MPLS header is not said special value.

8. The method as claimed in claim 1, wherein said egress MPLS device, after receiving said packet, performs the following steps:
determining whether the value of said bottom of stack field of the topmost header of
said packet is 0 or not; and
if the value of said bottom of stack field is 0, repeating reading the next header and checking the value of said bottom of stack field of said next header until the value of said bottom of stack field is 1.
